(19) United States
(12) Patent Application Publication
(10) Pub. No.: US 2008/0175239 A1
(43) Pub. Date: Jul. 24, 2008

(54) Multicast wide-area network for distributing data to selected destinations with limited or no replication

(75) Inventors: Kamran Sistanizadeh, San Francisco, CA (US); Patrick H. Douglas, San Francisco, CA (US)

Correspondence Address: MCDERMOTT WILL & EMERY LLP, 600 13TH STREET, N.W., WASHINGTON, DC, 20005-3096, US

(73) Assignee: YIPES ENTERPRISE SERVICES, INC

(21) Appl. No.: 11/802,629

(22) Filed: May 24, 2007

Related U.S. Application Data
(60) Provisional application No. 60/886,159, filed on Jan. 23, 2007.

(51) Int. Cl. H04L 12/28

(52) U.S. Cl. 370/390

(57) ABSTRACT

The disclosed techniques provide a multicast extranet service via L2 wide-area network, by provisioning the network to define a virtual local area network (VLAN) for wide-area network distribution of each data feed from a source to edge points (intelligent points of demarcation), without replication for individual users within the wide-area network. A specific VLAN is assigned to carry each multicast content feed and is allocated bandwidth, to make content available at multiple designated edge points. A user network interface, such as implemented at the intelligent edge points, is configured to allow authorized user(s) access to requested data feeds from respective VLANs. Dynamic signaling may be utilized by users of the network to select data from the broadcasts on the VLANs. The signaling to/from each user device may be L2 or L3 to the points of demarcation.

### RELATED APPLICATIONS

This application claims the benefit of U.S. Provisional Application No. 60/886,159 Filed Jan. 23, 2007 entitled “Multicast Wide-Area Network for Distributing Data to Selected Destinations with Limited or No Replication,” the disclosure of which also is entirely incorporated herein by reference.

### TECHNICAL FIELD

The subject matter in this disclosure relates to techniques and equipment for an enhanced wide-area network for distributing data to multiple designated destinations with reduced cost and latency, and more specifically, to providing a multicast extranet service via layer-2 (L2) switched Ethernet wide-area network, by provisioning the network to utilize multicast protocol or define VLAN for wide-area network distribution of content from source to edge points of network, with limited or no replication within the wide-area network.

### BACKGROUND

In recent years, the financial industry increasingly uses data networks to execute trades and/or transmit market and/or trade data. Conventionally, the data is distributed from a data source, such as a stock exchange or a data service company, to remote authorized data recipients or users, such as traders and investors, utilizing a point-to-point extranet and/or multicasts involving Layer-3 (L3) protocols. The delivery of the data from the data source to the authorized data recipients or users usually is performed by a data transport service provider. An extranet is a logical network built on top of a physical network that inter-connects private networks for sharing information, specifically allowing access via the web only to authorized members of particular work groups or authorized users. An extranet must meet network access and security requirements of the individual client or corporate networks that it serves. However, Layer-3 protocols are complicated to provision, more expensive to operate, and require greater troubleshooting expertise. Additionally, the size of market and trade data is usually very large, especially when continuously streaming real-time market data. Layer-3 technologies require replication and redistribution of the data to each discrete connection, which translate to high bandwidth requirements and high cost.

Furthermore, the financial markets are extremely sensitive to latency (down to the microsecond level) and jitter. Any delay or disruption in transmitting and receiving market and/or trade data usually cause significant differences in execution prices and market trend. However, Layer-3 multicasting protocols tend to add latency and jitter to the transmission of trade and market data.

Hence, a need exists for a multicast data transmission network with reduced cost and latency. There is also a need for a data transmission network that could handle high data volume with reduced replication and distribution bandwidth requirements. Although the need is exemplified by distribution of financial data, similar needs are emerging for multicast distribution of other types of information from data feeds, such as video games, entertainment video, multimedia distance learning and the like.

### SUMMARY

The teachings herein alleviate one or more of the above noted problems and/or meet one or more of the above-identified needs. The disclosure describes various examples of data transmission networks which achieve reduced cost and latency for multicast distribution. The resulting networks and/or operations thereof significantly reduce or eliminate the drawbacks caused by multicast transport using Layer-3 protocols.

A system, for example, as disclosed herein provides a multicast wide-area data distribution service. The system includes a layer-two (L2) frame switched wide-area network. A first switching device, on an edge of the wide-area network, provides a network interface for receiving data from a data source for the multicast wide-area data distribution service. The received data comprises data feeds. The first switching device sends L2 frames containing the received data into the wide-area network. The system includes second switching devices at various locations on an edge of the wider-area network. The second switching devices provide instances of a user-network interface for supplying data from the L2 frames to customer premises for delivery to data user client devices. L2 virtual local area networks (VLANs) are provisioned through the wide-area network to extend from the first switching device to the second switching devices. Each VLAN provides multicast distribution transport of L2 frames containing one of the data feeds, from the first switching device to the second switching devices, without replication for individual data user client devices inside the wide-area network. The user-network interface provided by each second switching device controls the delivery of selected data feeds from the L2 frames of the VLANs, in response to requests for data from one or more respective client devices of authorized data users.

The disclosure also encompasses methods for multicast wide-area of data distribution via a layer-two (L2) frame switched wide-area network. An example of such a method involves receiving data from a data source for the multicast wide-area data distribution service at a first switching device on an edge of the wide-area network. The received data includes a number of data feeds. The wide-area network provides multicast distribution transport of the L2 frames containing data feeds to second switching devices at various locations on an edge of the wide-area network. The L2 frames for each data feed are transported through the network via respective L2 virtual local area networks (VLANs), each of which is provisioned through the wide-area network to extend from the first switching device to the second switching devices. This VLAN transport provides multicast distribution to the second switching devices, without replication for individual data user client devices inside the wide-area network. The methodology further entails receiving requests for data from the multicast wide-area data distribution service, from one or more respective data user client devices at the second switching devices. Selected data feeds from the L2 frames are supplied to customer premises for delivery to data user client devices, in response to requests received from authorized users.

An exemplary network provides a multicast extranet service via L2 switched Ethernet wide-area network, by provisioning the network to define a virtual local area network (VLAN) for wide-area network distribution of content from a source to edge points of the network (intelligent points of demarcation) with little or no replication within a wide-area network. Multiple VLANs are provided for broadcast of multiple data feeds or streams of data from the source(s). Authorized users connect to the edge points of the network. A specific VLAN is assigned to carry multicast content from a particular source and is allocated a certain amount of bandwidth, to make content available at multiple designated points without duplicate copies. Network interfaces, such as implement the intelligent edge points, are configured to allow authorized user(s) access to requested data from the VLAN. Dynamic signaling may be utilized by users of the network to select data from the broadcast on the VLAN. The signaling to/from each user device may be L2 or L3 to the points of demarcation, however, the data transport through the network (edge to edge) uses L2. The exemplary network may use multicast protocols, such as Internet Group Multicast Protocol (IGMP) or Protocol Independent Multicast (PIM), to manage authorized users of the network.

The VLAN for a data feed is defined across multiple demarcation points or user devices. In one aspect, the VLAN is set to be available to all points of demarcation and/or all L2 edge devices. An end user signals a demarcation point to request a copy of the data. Based on the user's profile or authorization status, the intelligent demarcation point allows the user to tap into the data feed on the VLAN to obtain the multicast content. The example manages user authorization via an ACL (Access Control List) at the switch or router providing the user-network interface. The ACL effectively provides logical separation of users so that VLAN traffic for different user groups is not mixed or misdirected. Only an authorized user, as indicated by the VLAN ACL can tap into and receive the data feed on that VLAN.

Within the network VLAN, i.e. between the edge providing the network interface for the source and the edge(s) providing the user-network interface for the end user client device(s), the data feed appears as a single copy, much like a single copy of a signal on a common bus or cable. As such, there is no replication for individual users or destinations inside the perimeter of the wide-area network. Data is replicated at and sent out from the network edges, when users tap into the VLAN data feeds.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional diagram illustrating an exemplary multicast network utilizing layer-2 architecture for VLAN distribution of data feeds.

FIG. 2 is a block diagram useful in explaining an exemplary user-network interface (UNI) at a demarcation point on the Layer-2 network.

FIG. 3 is a block diagram useful in explaining an exemplary network-network interface (NNI) for coupling the Layer-2 network to Layer-3 feeds from source(s).

FIG. 4 is a conceptual diagram showing aggregation of data from different sources, bundling the data into one or more groups, for packet or frame transport through the L-2 network via designated peering points.

FIGS. 5A and 5B are flow diagrams related to a service scenario in which an end user requests access to a data feed, at a time when there has been no prior signaling. FIG. 5A illustrates an example of this scenario with layer-2 signaling, whereas FIG. 5B illustrates an example of this scenario with layer-3 signaling.

FIGS. 6A and 6B are flow diagrams related to a second service scenario, in which an end user requests access to a data feed, at a time when the requested multicast data feed is already flowing on the data provider's network. FIG. 6A illustrates an example of this scenario with layer-2 signaling, whereas FIG. 6B illustrates an example of this scenario with layer-3 signaling.

FIGS. 7A and 7B are flow diagrams related to a third service scenario, in which an end user requests access to a data feed, at a time when the requested multicast data feed is already flowing in the wide-area network. FIG. 7A illustrates an example of this scenario with layer-2 signaling, whereas FIG. 7B illustrates an example of this scenario with layer-3 signaling.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The disclosed network provides a multicast extranet service via L2 wide-area network, by provisioning the network to define a virtual local area network (VLAN) for wide-area network distribution of each data feed from a source to edge points of network (intelligent points of demarcation) without replication for individual users or destinations within the wide-area network. Authorized users connect to edge points of the network. A specific VLAN is assigned to carry each multicast content feed and is allocated bandwidth, to make content available at multiple designated points. A user network interface, such as implemented at intelligent edge points, is configured to allow authorized user(s) access to requested data feeds from respective VLANs.

Replication, in a packet or frame switched network, occurs when a node of the network generates one or more copies of the packets of a data feed from the source for delivery to allow delivery of the particular data feed to two or more destinations. Delivery of a data feed to 100 customers, for example, would result in 100 copies of the data feed flowing through the network. The VLAN does not require separate copies within the wide-area network for each destination. From the edge where a data feed is received from a source to the edge providing the interface to the end user customer premises, there is only one instance of the data feed. Replicas for individual user client devices are only generated at the edge providing the user-network interface for transmission outside the wide-area network, i.e. at the handoff of the data to the user's customer premises.

In the example, the VLANs for the respective data feeds also have associated access control lists (ACLs). The intelligent edge device receives an access request form a user, checks the ACL for the requested data feed and determines whether the user is authorized to access the particular data feed. If so, then the edge device enables the user's device to tap into the data feed from the VLAN. In this way, the network assures separation of data feeds and of users or user groups authorized access to respective data feeds and thereby insures that data is not supplied to the wrong user.

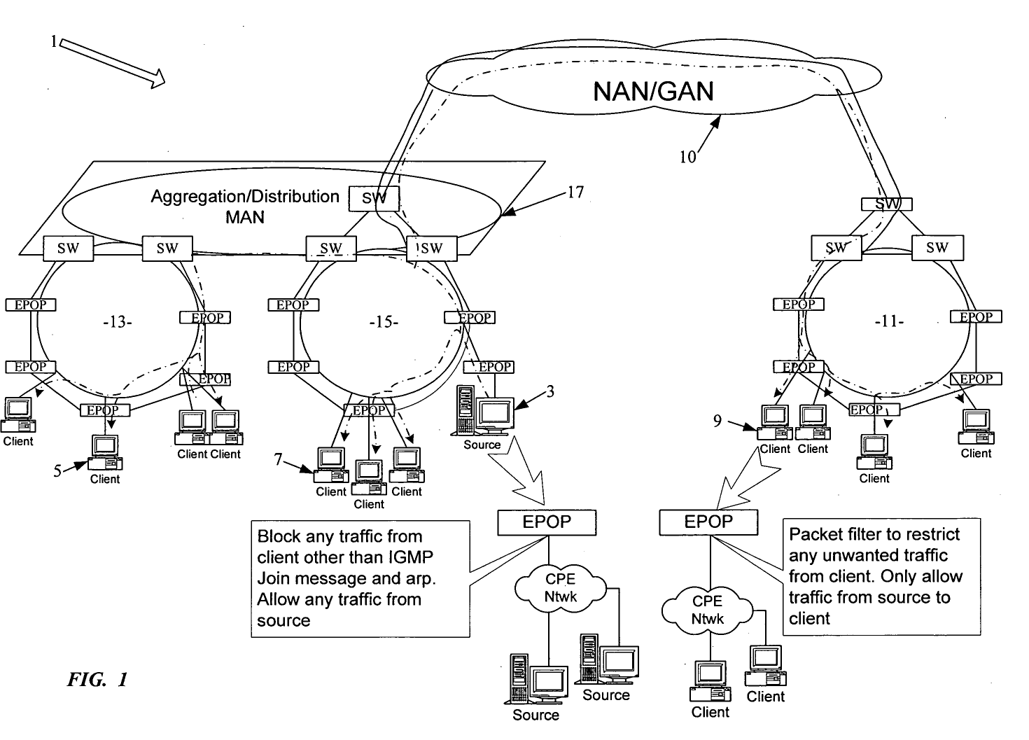

Reference now is made in detail to the examples illustrated in the accompanying drawings and discussed below. FIG. 1 illustrates an exemplary multicast network 1 utilizing layer-2 architecture for transporting data from a data source to an end-user customer subscribing or authorized to receive the data from the data source. In general, the network may be similar to networks disclosed in U.S. Pat. No. 6,963,575 to Sistanizadeh et al. the disclosure of which is incorporated herein by reference. The exemplary network typically offers other types of services, e.g. based on point-to-point communications, e.g. as in the Sistanizadeh et al. patent. However, the discussion here focuses on the operations of the network 1 relating to the multicast service. The multicast capabilities of the network 1 offer transport service for any type of data that a customer may want to distribute, from one source 3 to a number (often many) end users of the data. End users access data on the network via client devices, e.g. personal computers or other data terminal devices, such as shown generally at 5, 7 and 9 in FIG. 1. Although only one source 3 is shown, there may be any number of multicast data sources offering different content data services. For ease of discussion, the example, will focus on multicasting of market or financial data, although those skilled in the art will recognize that the principles involved are applicable to multicast distribution of other types of data.

A Layer-2 (L2) network 1, such as a metropolitan area network (MAN), national area network (NAN) or a global area network (GAN), provides one or more points for connecting to one or more data sources 3, and one or more points for connection with client devices 5, 7 or 9 for users subscribing to receive data from the data source 3. The exemplary Layer-2 network 1 includes a wide-area backbone or core network 10 and a number of local access ring networks. Some local access rings such as ring 11 may connect to the core network. However, in some regions, rings such as 13 and 15 may connect to an intermediate aggregation and distribution network such as the ring 17. Each access ring network 11, 13 or 15 comprises edge-point of presence (E-POP) switches and data links from the E-POP switches to individual devices 5, 7 or 9 at client locations or to data sources 3.

Multicast protocols, such as Internet Group Multicast Protocol (IGMP) or Protocol Independent Multicast (PIM) signaling, are used by the exemplary network 1 to control multicast floods. The exemplary network includes one or more logical networks, such as a virtual local area network (VLAN), for grouping one or more client computers based on their authorization or subscription status. In practice, there are typically multiple VLANs, each carrying a different data feed for a different group of authorized end users. Computers associated with the same VLAN behave as if they are connected to the same wire, even though they may actually be physically connected to different segments of a network or different networks. The VLANs may be port-based, MAC-based, protocol-based or authentication-based. In one instance, only those clients that have subscribed to access data from the data source are allowed to have access to the VLAN that carries data from that source. A configuration process may be performed on a respective client's equipment or any interface devices between the exemplary network and the client's network or system, such that that client's system or network is properly associated with a specific VLAN providing the subscribed data.

An aspect of this disclosure defines the VLAN across multiple demarcation points or user devices. In one example, the VLAN is set to be available to all points of demarcation and/or all L2 edge devices. A client device of each end user signals an edge device at a demarcation point to obtain a copy of the data based on the user's profile or authorization status, to tap the VLAN at the intelligent demarcation point. An intelligent interface may be provided to interface between the L-2 network 1 and each client device, to dynamically determine an authorization of a client's access to a specific content feeds within the VLAN. Communications between a client device and an intelligent interface may be compliant with L-3 or L-2 signaling protocols. The interaction of layer-2 and layer 3 signal formats is performed by an access ring switch, E-POP, customer premises equipment, a conversion device, or any device capable of performing this function.

Ethernet switches used in the illustrated network segregate a network 1 into a number of virtual local area networks (VLANs), for example to support several instances of the MAN service. In a normal VLAN application, the VLAN provides private data service between limited numbers of customer sites. In such a VLAN mode of operation, data switches transport frames (encapsulating packets) back and forth between terminal stations designated as members of a particular VLAN. However, the switches of the network do not transport the packets for the VLAN members to any other terminal stations. In this normal VLAN processing, the capability exists for creating logical workgroups of users and their shared resources (servers, printers, etc.), which may be physically separated from each other. Members of a workgroup may be coupled directly with one switch in the local area network, while other members or equipment of the workgroup may be coupled to one or more remote networks that are linked to the switch at a network port. VLAN groupings can provide privacy and security to their members while enabling “broadcast domains” whereby broadcast traffic is kept “inside” the limited member group of the VLAN.

Where the switches implement two or more virtual local area networks (VLANs), the switches distinguish the frames for members of one VLAN from frames for members of a different VLAN and from frames for devices not associated with any one VLAN. All VLAN frames may be tagged with data identifying the particular VLANS. Hence, data frames communicating within a VLAN may contain information that identifies the VLAN grouping, or VLAN type, and the particular VLAN ID. Such information, or “tag,” is provided as additional fields in the frame header. The frame format for such packets is expanded relative to the standard frame format. For example, the Ethernet IEEE 802.3 standard specifies the untagged frame format and the 802.1q standard specifies tagged frame format. IEEE 802.1P also provides priority tags in the Ethernet frame headers. The data switches queue the frames in accord with these priority tags.

Conventional use of VLANs maintains a separate private and secure VLAN for each customer. However, if the conventional use of VLANs were used for multicast service, each customer would need a private VLAN between their site and a data source, such as a stock exchange. Each VLAN needs to carry an identical copy of the multicast feed set. This distribution method results in numerous copies of identical high-volume multicast feeds on the network that rapidly and unnecessarily consumes bandwidth.

On the other hand, according to an exemplary network of this disclosure, customers or data recipients are grouped into logical groups according to their respective subscription or authorization status of each type of data feed service. All customers authorized to access to the same data feed service are grouped in a single, common logical network, such as a single VLAN, with a multicast feed intended to be distributed to all customers or subscribers that are part of, or tapped to, the logical group with which the VLAN is associated. Since during each multicast of data feed, only one VLAN is involved for all customers or subscribers authorized to access the multicast data, only one copy of any data feed appears on the VLAN of the exemplary network. The traffic and needed bandwidth are dramatically reduced compared to the multiple distributed copies on multiple VLANs. According to one example, different types of data feeds, such as NASDAQ market data, NYSE market data or LSE market data, are associated with different logical groups of customers or subscribers who are authorized to access the respective data feed. For each logical group, a single VLAN is provided to all customers or subscribers in that group.

An example of a Layer-2 network 10 is an Ethernet network implemented over fiber networks, e.g. as in the Sistanizadeh et al. patent. Service of Layer-2 networks is available from Yipes Enterprise Service, Inc., of San Francisco, Calif. In the MAN/NAN, a resilient optical fiber access ring interconnects the aggregation data switches of the access rings 13 and 15, to form a distribution ring 17. Data links connect the edge data switches to end-user data systems. The data links provide two-way transport using Layer 1 (physical) and Layer 2 (framing/switching) protocol elements of a local area networking protocol, preferably Ethernet. The access rings and the backbone distribution ring utilize the layer 1 and layer 2 protocol elements of the local area networking protocol to directly provide two-way data communications transport over the rings, that is to say without the use of other lower level protocol elements on the fiber links. In the Ethernet embodiment, the rings provide direct transport of Giga-bit Ethernet protocol signals. Certain inventive aspects, discussed below, relate to manipulations of switching and routing protocols utilized in the network, to optimize services and operations thereof. Layer 1 of the Ethernet protocol is a physical layer signal protocol for data communication. Layer 2 of the Ethernet is the MAC layer addressing and framing protocol, which indicates where to send the frames. The inventive network utilizes Layer 1 and Layer 2 elements of the Ethernet protocol throughout the various rings and for communication to and from the client premises. The connectivity for the MAN services, for example, relies on layer-2 protocol switching functions. The Ethernet L1 protocol elements essentially define the encoding of the ones and zeros for application to a physical media. The Ethernet L2 protocol elements define the framing structure and in some cases any multiple-access procedures for allowing multiple devices to access each individual shared media. Layer 2 also provides mechanisms for segregating traffic of multiple clients that may share a portion of the network, for example, into virtual local area networks (VLANs). Further details of a Layer-2 based wide-area data transmission network are discussed in U.S. Pat. No. 6,963,575, issued on Nov. 8, 2005 and titled ENHANCED DATA SWITCHING/ROUTING FOR MULTI-REGIONAL IP OVER FIBER NETWORK; and U.S. Pat. No. 6,681,232, issued on Jun. 20, 2004 and titled OPERATIONS AND PROVISIONING SYSTEM FOR SERVICE LEVEL MANAGEMENT IN AN EXTENDED-AREA DATA COMMUNICATIONS NETWORK, the entire disclosures of which are incorporated by reference.

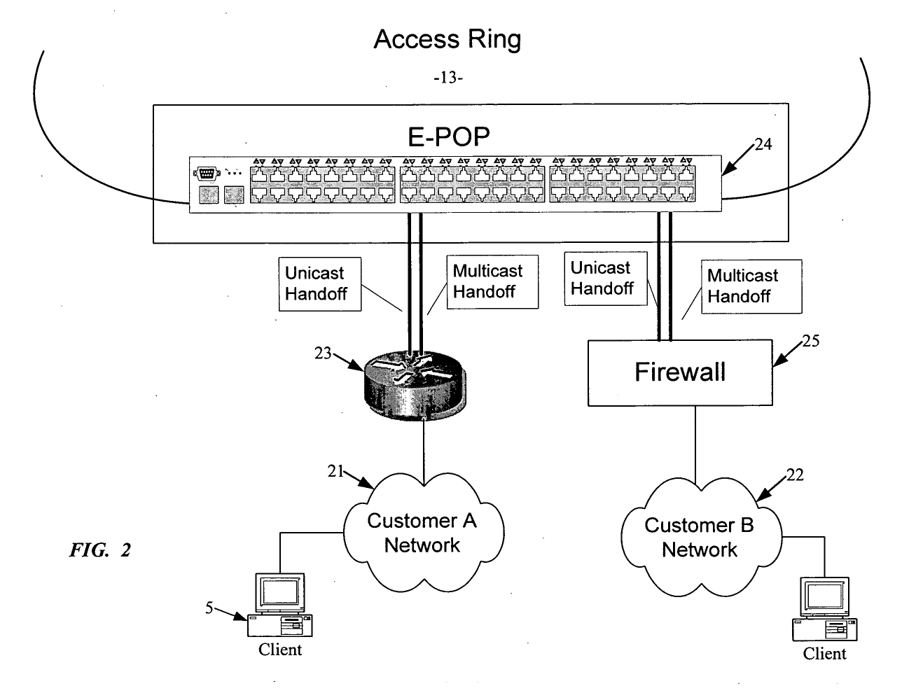

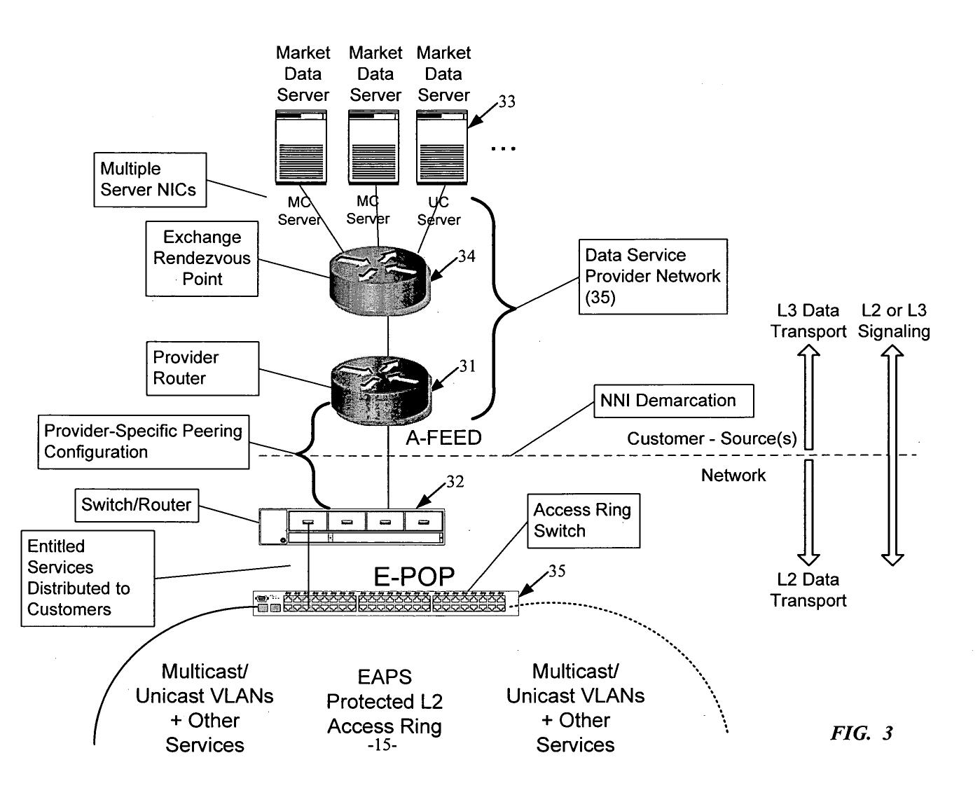

To send and/or receive data, the clients' systems are connected to the Layer-2 network 1 through a user-network interface (UNI) at a demarcation point on the Layer-2 network 1, and data source's system is connected to the Layer-2 network 1 through a network-network interface (NNI). In the network 1 shown in FIG. 1, the UNI and the NNI are implemented in appropriate edge point of presence (E-POP) L2 switches. FIGS. 2 and 3 illustrate exemplary UNI and NNI, respectively, that could be used to connect to the Layer-2 network 1. An exemplary implementation of UNI or NNI is by connecting edge-point of presence (E-POP) devices and the respective client premises equipment (CPE) for a source 3 or client device 5, 7 or 9.

FIG. 2 shows examples of multicast IP UNI interconnections. Although a direct connection could be provided to an end user device, typically the client devices are affiliated with private networks, two of which 21 and 22 appear in the drawing. All data transport for the multicast services in network 1 uses L2 VLANs, however, some customers may require conversion at the edge. Signaling may be at L2 or L3. The client A uses a router 23 to connect to an E-POP switch 24 of one of the local access rings of the network 1 (FIG. 1), such as the ring 13 in this example. This design provides L3 handoff of data feeds (delivered to the edge device 24 via Layer-2 VLANS), into the customer network 21 and supports L3 signaling. Another client B uses a firewall 25 to connect to the appropriate E-POP switch 24. This design is used whenever a client customer requires an IP handoff for one or more multicast data feeds from a source 3. Typically this handoff is with the assumption (though not the requirement) from the customer that network 1 will distribute the data feeds using L2 switching with L2 or L3 signaling.

The typical peering arrangement for this design is with both unicast and multicast routing protocols, and a combination of unicast and multicast services being delivered. Typically this is one data feed service per VLAN or physical handoff with separate peering on each VLAN or link. Multicast Protocols handle group registration, and unicast routing protocols distribute the customer IP space required by the unicast services and by the multicast group protocols for building a distribution tree for the multicast stream back to the client over an IP network.

FIG. 3 depicts an example of a multicast unicast IP NNI, such as might be provided for an exchange or other marketer of financial data products that requires an IP handoff for unicast and multicast data feeds. The network operator deploys a router 32 for this scenario to terminate the IP handoff (L3) from the servers 33 of the data marketer, via a router 31 of the data service provider's network 35, that is to say the network 35 of the marketer. For some signaling implementations, the network 35 may include a rendezvous point 34. A rendezvous point is a PIM intermediary. The PIM signaling functions of the rendezvous point 34 may be implemented in a separate router as illustrated in the drawing, or the rendezvous point may be implemented as an additional function of the customer-side NNI router 31.

The router 32 converts the L3 data feed from each source server 33 into a L2 VLAN tagged data stream for handoff to the access ring. In the example, the router 31 connects to an E-POP type switch 35 in one of the access ring networks, such as the ring 15. The wide-area network 1 will distribute the data for each feed through corresponding VLANs as normal using the Multicast-Aware Layer-2 Extranet design (see FIG. 1). The router 32 also supports L3 signaling with the source servers 33 and signaling through network 1. The peering arrangement for this design includes both unicast routing protocols and multicast group protocols. Multicast protocols handle group registration, and routing protocols distribute the customer IP space as required by the multicast group protocols for building a source tree back to the financial data servers over the marketer's IP network.

The illustrated design is for a Multicast-Aware extranet with the addition of IP routing and multicast NNI with the data provider equipment. The data provider will handoff a tagged Gigabit Ethernet link containing one multicast feed per VLAN. Each VLAN requires a /30 IP Address managed by the data provider. The peering arrangement for the unicast VLANs is BGP. The peering arrangement for the multicast VLAN is RIPv2 and PIM for multicast group registration. The network operator's router 31 will accept feeds from the sources 33 and route them all into a single common Extranet attached to all clients. IGMP will control the feed distribution in L2 network 1. Clients and servers generate IGMP signals. These IGMP signals are brokered through the NNI. IGMP signals PIM to build a tree from a source network where the feeds originate to the client network. For this design, that amounts to a point-to-point link from the router 31 associated with the data provider to the interface on the network router connecting the L2 Multicast-Aware Extranet. The network operator does not have to address switches in the data services extranet. The clients are configured in the assigned address range or their requests will not make it through the router. The network operator can connect multiple extranets to ports on the NNI router 31, with each Extranet configured in a different IP address range (and clients addressed accordingly). The IP addresses would be either publicly registered, or RFC1918 compliant private address and a NAT solution to avoid overlap with other providers. The network operator will use public addressing to the extent possible.

The network and source equipment of the data provider peer BGP on Unicast VLANs and RIPv2 on the multicast VLAN. RIPv2 may be used to advertise the client address space to the customer for the purpose of building PIM source trees. The network operator and the data service provider will peer PIM on the multicast VLAN. This will allow the servers to advertise their services to the clients through a router, and enable group registration from the clients to the servers. The only PIM trees that will be built however will be between the network router and data provider's router 31 (one per multicast group). Once the multiple multicast groups are routed to the extranet VLAN, multicasts will flood the Extranet as normal in a manner controlled by IGMP.

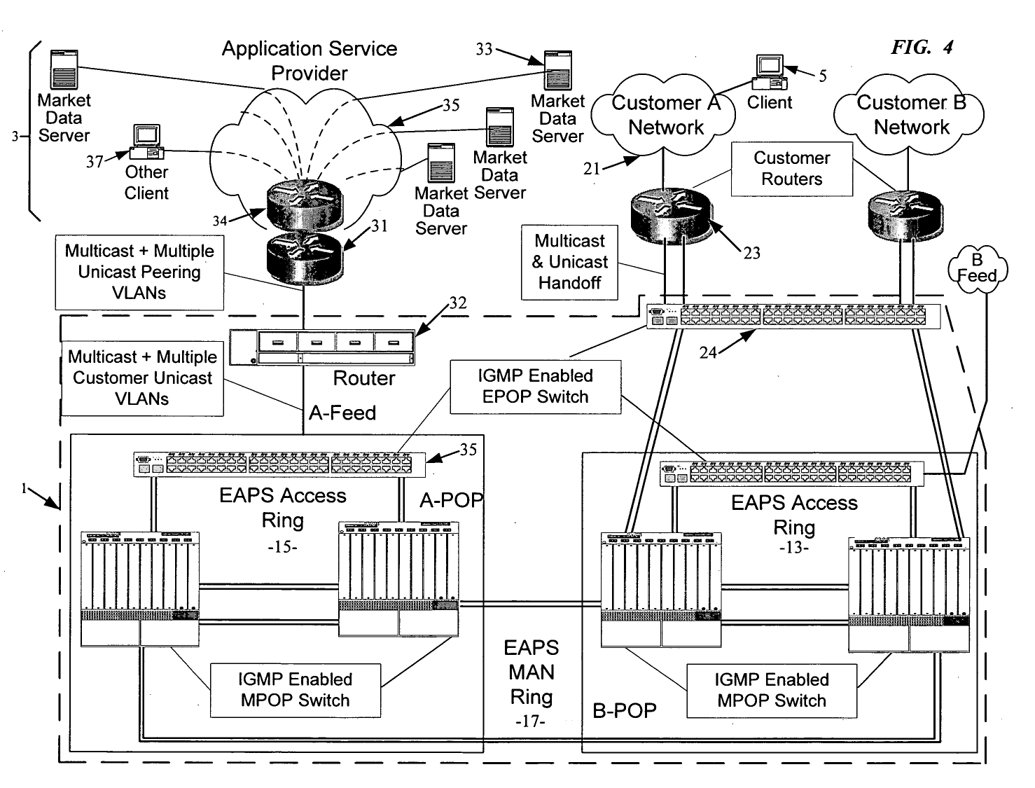

Details of the operation of the exemplary network are now discussed using examples of a financial data source transmitting financial data, e.g. relating to a financial market exchange, to clients who subscribe to the particular data service. FIG. 4 is a conceptual diagram showing a data source 3 that aggregates data received from different data servers 33, bundles them into one or more data feeds, puts them in proper network packets or frames, and then hands them off to L-2 network 1 over designated NNI peering points, and the illustration in FIG. 4 includes aspects of the UNI and the NNI useful in explaining signal flows that are discussed later. A data source is an entity that owns and/or resells data, in this case an exchange or the like that produces and sells financial data, to its clients through the L-2 network 1. As depicted in FIG. 4, exemplary data sources include one or more market data servers 33. The client devices 5 and 37 may include trader station computers residing at a service subscriber's location running a financial application. The client device 5 receives service via the wide-area network 1, as discussed in more detail below. The network 35 of the data service provider, e.g. an exchange network, may also offer service to other user devices 37, via the network 35 or via connections to legacy networks not separately shown.

As illustrated in FIG. 4, examples of clients include two customer networks A and B connected to the exemplary L-2 network 1, one of which includes a client device 5 receiving the multicast service of the network 1. Hence, the router 23 of the customer network 21 connects to the E-POP switch 24 on the local access ring 13. The client device 5 communicates with the network 1, and thus accesses data feeds on one or more of the multicast service VLANs, via the network 21, including the router 23.

A data transport provider operates a high bandwidth fully redundant network 1. The network is designed around optical rings and fully redundant network equipment, media, database and application servers. Feeds are streams of unicast and multicast packets that carry financial data as payload from one source to one destination (unicast) or from one source to many destinations (multicast) on the L-2 network 1. Examples of data feeds include feeds carrying buy and sell positions of various assets such as equities, options, commodities and futures, and currency instruments. Throughout this disclosure, the term feed, financial feed, financial data are used interchangeably.

The data servers 33 connect to the L-2 network 1 via NNI peering points, and customer networks A and B which subscribe to the data source's data service are connected to the L-2 network 1 via the UNI. In order to connect to the customer networks A and B, the exemplary network 1 includes VLANs that have UNI/NNI end-points as member ports. VLANs may carry one or more data feeds that are to be multicast in common to authorized user groups. Traffic engineering is applied based on a per feed basis and subscriber credentials. In one example, unicast feeds are carried in dedicated VLANs or in two VLANs for redundancy, and multicast feeds are carried within designated multicast VLANs that serve multiple subscribers or clients. All feeds are carried over self-managed application-aware layer-2 logical pipes that leverage advanced layer 2/3 technologies such as 802.1Q, 802.1p, EAPS (Ethernet Automatic Protection Switching), MPLS (Multi-Protocol Label Switching), VPLS (Virtual Private LAN Service), IGMP (Internet Group Multicasting Protocol) snooping, and PIM (Protocol Independent Multicasting) and PIM snooping.

As illustrated in FIG. 4, an exemplary network 1 connects between multiple market data servers and customer networks A and B, such as computers in branches of a bank. Upon receipt of multicast stream and unicast IP flows, service switches coupled to the exemplary network 1 wrap the IP packets in Ethernet frames, mark the wrapped packets with tags or labels and send the packets to the next switch on its path to its destination UNI (for unicast feeds) or UNIs (for multicast feeds). Intermediate switches inspect frame headers for tag analysis and make decisions as to drop, mark or pass-through of the packets. The logical hop distance between a provider router 31, such as associated with the market servers 33 shown in FIG. 4, and a client device 5, such as on the customer network A 21 as depicted in FIG. 4, on the exemplary network 1 is two (2). Because of the use of VLANs, only the devices at the ends (connected to the source and destination) appear as layer 3 routers. For clients or subscribers participating in PIM operations, the logical hop distance will be reduced to one (1). The IP packet is carried within VLAN frames on its journey from the NNI to the UNI and is therefore invisible to intermediate IP stacks. Financial data is switched and never leaves the body of an Ethernet frame and the boundaries of dedicated VLANs. However, the layer 2 Ethernet switching delivers the VLAN frames containing the content packets to all demarcation points at the edge of the network.

The financial data payload is transparent to the L-2 network 1. Only the header is inspected when a packet or frame enters or leaves the L-2 network 1. Ingress traffic is usually marked as it enters the L-2 network 1 at the NNI or UNI. The marking process may involve tagging, tag stacking, tag swapping, labeling, label switching, etc., or any combinations thereof. Switch nodes along the path from the NNI to the UNI use the markings to make routing and switching decisions. At the edge of the L-2 network 1, clients have the option to connect to the exemplary network at layer 2 or layer 3. A layer-2 handoff means exchanging IGMP signaling with the L-2 network 1. Layer-3 handoff implies excha nging L-3 signaling with the L-2 network. Clients may request the payload (financial data feed) to be handed off over the UNI as IP packets, or as tagged frames or as others.

In an operation of an exemplary network 1, clients subscribe to the service of the exemplary network to receive financial data from data sources, such as NYSE and NASDAQ feeds. All unicast and multicast feeds between the client UNI interface and NNI source interface are carried on dedicated secure layer-2 switched VLANs that have the provider and the consumer as the only two leaves. These VLANs span from a router/switch, collocated at one or more NNI peering points, across the exemplary network up to the port on the edge device that talks to the CPE at the UNI. Within this VLAN span, there is no replication of data for individual end users or their devices. In this way, all multicast traffic is carried on a VLAN spanning from service router/switch (that is collocated with the data center and receives L3 and L2 traffic through the NNI) all the way to network edge device (that connects to the client CPE thru UNI), without replication. According to one example, an exemplary inventive network is IP L3 multicast-signaling aware and is capable of maintaining L3 properties end-to-end. The exemplary network utilizes advanced layer-2 features and properties, e.g., VLAN, L2 MPLS, VPLS, EAPS, IGMP snooping, etc, to carry the financial payload within Ethernet frames. Data distribution not involving layer-3 is faster, for packets never leave layer 2 unless they arrive at the edge of the network. The L2based distribution scheme also offers a higher degree of security in terms of packet delivery and sensitivity of financial data when compared to L3-based Extranets (including MPLS based VPNS), as packets are not examined by IP stacks of intermediate node. According to one example, an exemplary network supports many layer-3 hand-offs at the NNI, and layer-3 signaling at the UNI, including PIM and PIM snooping, RIP (Routing Information Protocol), OSPF (Open Shortest Path First) and BGP (Border Gateway Protocol), if layer-3 communications are needed to communicate with data sources or customers.

In one example, an exemplary network provides a router for interfacing with a data source that runs PIM signaling. Customers signal IGMP directly to the router with their workstations to request multicast feeds. IGMP Snooping is run on the Layer-2 switches in the exemplary network to control multicast floods. According to another example, customers' systems may peer PIM with NNI routers of the exemplary network. In this case, data is distributed on the exemplary network using layer-2 (L2) protocols. No other protocols are peered between the customer and the exemplary network. In this case, Layer-2 switches of the exemplary network run PIM Snooping and IGMP Snooping to control multicast flooding.

VPLS is a multipoint virtual private network (VPN) service that connects any number of Ethernet LANs together over an IP core, typically using MPLS, although other encapsulation protocols can be used. MPLS is a standard including routing information in the packets of an IP network. MPLS is used to ensure that all packets in a particular flow take the same route over a backbone. MPLS can deliver the quality of service (QoS) required to support real time voice and video as well as service level agreements (SLAs) that guarantee bandwidth. Large enterprises may also use MPLS in their national networks. When market data needs be distributed to a remote system, the remote system connects an exemplary network providing Layer-2 Multicast, with a VPLS connection configured in the same common VLAN. Multicast flood control in the VPLS cloud ensures data be distributed only to remote systems where requests were received for specific multicast groups.

According to one example, communication between a customer's system and an exemplary network's edge device is confined to the IGMP signaling protocol. A customer's system sends an IGMP Join signal requesting membership to a multicast group carrying a data stream. This IGMP Signal is understood by all Layer-2 switches of the exemplary network to mean open the customer ports in the VLAN to the multicast group being requested. When the IGMP signal reaches the interface between the exemplary network and a data source providing the multicast data, such as an NNI router, the router signals to the carrier using PIM. The router is joined to the requested groups and conveys the data via the customer-facing Extranet port at Layer-2 directly to the customer's system.

Customer access to specific groups is controlled/validated by Access Control Lists (ACLs) which specify which customer is authorized or allowed to access a specific data feed or a VLAN associated with a data feed. If a customer cannot send an IGMP Report to the group they are requesting, they cannot join the group and receive the requested data feed. An exemplary network implemented using the concepts disclosed herein places an ACL specifying the multicast IP range with a Permit on groups customers that are allowed to transmit reports, and a Deny on all other groups. A customer request for an un-entitled group will be blocked by the ACL, and the NNI router of the exemplary network interface the data source providing the data feed will never receive the request signal. The customer-facing switch of the exemplary network will drop the IGMP request prior to processing the request so the customer port is never opened for the un-entitled feed. For entitled feeds, the ACL permits the IGMP Report to pass and the signaling happens normally. The ACL also allows for other traffic as needed (such as IGMP Leaves). All other traffic is blocked so that customers cannot connect with each other.

According to one example, the demarcation point between an exemplary network of this disclosure and a customer's system is a layer-2 switch with an Access Control List configured. The ACL controls customer interaction and access as mentioned above. The customer's equipment allows the host IGMP signaling to propagate to the exemplary network's switch. The customer's system may be a switch, a firewall, a router running a bridged connection or IGMP proxy, or any other types of connection devices that are used by a customer to connect to the exemplary network.

Integration with the exemplary network is a straightforward process. Within the exemplary network, from UNI to NNI or vice versa, traffic is switched and not routed. The exemplary network allows sellers and aggregators, with proper access rights, to announce and send financial data to their clients. Also, any entity, with appropriate access privileges, can indicate interest in and receive this data. A network operation center may monitor operations of the exemplary network round the clock, which includes management of all physical and logical elements of the network, including transport and transit circuits, network nodes, ports, routing and signaling operations, service health, and the like. In addition, network management servers and probes continuously collect, measure and report on data delivery on the exemplary network in terms of packet and frame loss, one-way and round trip delay, and jitter to name a few. These parameters are accessible by the Client in real-time.

A transport service provider may utilize a multicast transport network to aggregate data from different data sources, such a NYSE and NASDAQ, and hand the data off to end user clients at peering points. The data source transmits streams of IP packets that carry financial data feeds as payload, over its NNI interface (peering point) to a network device coupled to the exemplary L-2 network 1. In the example of FIG. 4, this device would be the network-side NNI router 32. The network device on the UNI side, typically the switch 24, maps customer's signaling requests into a prescribed signaling format required by the data source to dynamically stream multicasts for distribution to a corresponding VLAN of the exemplary network 1. The network device on the UNI side may be a router for peering with the data source, or a switch where the exemplary network and the data source are peering with Static IGMP Groups at the NNI. For instance, the customer's system may issue IGMP Signals that trigger PIM Join signals to the data source. In another example, static joins may be performed with the data source to transfer all data into the UNI switch/router, and then dynamically feeding the data out from the device based on customer dynamic IGMP Signaling.

Clients subscribing to data service provided by the data source utilize client routers and edge devices to connect the exemplary L-2 network 1.

The network device encapsulates the IP packets into Ethernet frames. The network device may use 802.1Q and P, and other techniques to prepare the frames for their journey on the exemplary inventive network. Data is carried either on unicast channels or on multicast channels across the exemplary network 10. A unicast channel is a traffic engineered application aware VLAN, that carries traffic between unique source-destination pairs only. Multicast flows are carried to one or more members or clients. Each multicast feed is also carried on a unique traffic engineered multicast VLAN. Channels can be fine-tuned to meet the needs of diverse applications.

Parties participating in the data transmissions using the exemplary network could be cities, countries or continents apart. Payload traffic never leaves the Ethernet layer 2 frame. Note that customer networks A and B in FIG. 4 perceive each other as being on their own private VLAN. Customer networks A and B can not use any signaling mechanism to obtain the IP addresses of other routers on the same VLAN. According to one example, intercontinental and inter-regional traffic, such as between Tokyo and New York or between New York and San Francisco, is switched over VPLS and MPLS.

In an exemplary network provisioned by multilayer physical architecture, the service delivery platform is divided into access, distribution and core planes. A data source connects to the exemplary network via Network-to-Network Interfaces (NNI). Data subscribers send and receive feeds via User-to-Network Interfaces or UNI. Logical and physical network components are provisioned for optimal and secure connections. Financial data packets experience the least possible delay and fast delivery across the layer-2 Ethernet links along their path from source to destination. Edge devices and service routers enforce security policies at the UNI and NNI, reject unauthorized access attempts and block unknown unregistered flows. Secure, reliable and fast transport uses layer-2 virtual local area network or VLAN and related technologies. Financial data traffic never leaves layer-2 once it leaves the data source. In the rare case of a ring, node, port or link failure, the network automatically fails over to optional alternative routes that may require a routed transport. Even in such situations, data is first encapsulated into point-to-point secure tunnels and then carried inside a layer-3 protocol.

According to one example, an exemplary network offers highly desired features of both layer-2 and layer-3 Extranets in one combined package. Financial data is carried inside IP data packets as payload, placed inside layer-2 Ethernet frames and carried on dedicated layer-2 tunnels end-to-end across the exemplary inventive network. As for Internet Protocol operations, the entire exemplary network is transparent and can be modeled as a single point-to-point switched Ethernet connection. In this model, the UNIs and the NNIs at the edge of the exemplary network appear to each other as the next IP neighbor. Feeds are carried transparently across the exemplary network within 802.1Q tagged network. The payload never leaves the layer-2 switching schema and as such is not visible to intermediate nodes across the UNI-NNI paths. L2 and L3 filters, counters, ACLs, and other security measures including wire-speed intrusion detection reduce un-authorized traffic entering or leaving the network. Multiple logical Extranets may co-exist on the exemplary network at the same time. Also, one client may be a feed provider (on one Extranet) and a feed consumer (on another Extranet).

To illustrate the operations of the multicast service through the exemplary network 1, it may be helpful to consider several representative processing flow in the arrangement of FIG. 4.

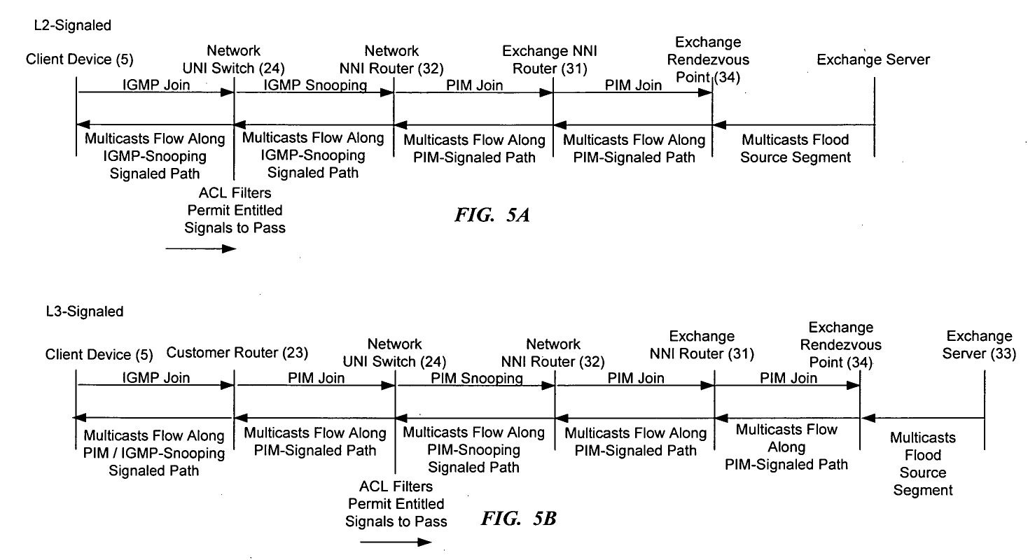

FIGS. 5A and 5B illustrate layer-2 and layer-3 signaled process flows for a service scenario in which an end user at client device 5 requests access to a data feed, at a time when there has been no prior signaling. For purposes of this example, we will assume that a trader using the client device 5 is requesting access to a financial market data feed from a source 33 on the network 35. At the point when the user requests access to the multicast data feed, the requested data feed is not presently flowing on either the wide-area network 1 or on the exchange network 35. In this case the signaling must propagate back to the rendezvous point 34, which advertises the desired data feed.

In the Layer-2 signaled scenario of FIG. 5A, the client application in device 5 is configured to send IGMP Join signals for the data feeds that it requires. Hence, to request the desired feed, the client device 5 transmits an IGMP Join type request message identifying the desired feed and sends that message through the customer network 21 (FIG. 4) to the IGMP-Snooping-enabled UNI switch 24 within the wide-area network 1. The switch 24 contains an ACL for each of the data feeds/VLANs that flow through it. The ACL function of the switch 24 filters signals by permitting only signals of authorized or entitled users to pass. Logically, the switch responds to the IGMP Join type request message by checking the ACL for the requested data feed, to determine if the requesting user is an authorized member of the group associated with the VLAN carrying that feed. If so, then the switch 24 opens the customer port for this data feed; and it propagates the IGMP Snooping signal through the Layer-2 network 1 to the NNI router 32 co-located at the data service provider site, at the financial market exchange in the example of FIG. 5A. Stated another way, if the switch determines that the user is authorized, the join signal is passed upstream and the data feed from the associated VLAN will be passed downstream for the user. If not authorized, the switch 24 does not pass the signals, particular the data feed in the downstream direction.

The NNI router 32 interprets the IGMP Signal, determines the group is not presently registered in the router, and formulates a corresponding PIM signal. The PIM signal propagates to the NNI router 31 and throughout the exchange PIM network 35 until it reaches the data service provider's rendezvous point router 34. The rendezvous point router 34 has a direct connection to the particular market data server 33 that produces the requested data feed. The server 33 floods multicast feeds to the rendezvous point 34 (without signaling) whenever the financial market is active. The rendezvous point router 34 is also responsible for sending multicast registration messages to other PIM routers (e.g. to NNI router 31), so they are aware of multicast data feeds that are available from that rendezvous point router 34.

The requested multicast data feed is permitted to flow back (only) along the path signaled by PIM to the exchange NNI Router 31 and the through network NNI Router 32. From the network side NNI router 32, the data is permitted to flow back (only) along the IGMP signaled VLAN path to the switch 24, without replication. As noted above, following the request, the switch 24 determined that the user was authorized access to the data feed on the particular VLAN, and the switch 24 opened the customer port for this data feed. Hence, when the VLAN provides the newly activated data feed to the switch 24, the switch supplies the data through the router 23 into the customer network 21, which routes the data to the client device 5 of the user/trader that requested access to the data.

In the Layer-3 signaled scenario (FIG. 5B), the IGMP Signal from the trader's client device 5 is sent to the customer side router 23. In this signaling scenario, that router interprets the IGMP Signal and formulates a PIM Join signal. Assuming the ACL indicates that the user is authorized to access the requested feed (as checked by the ACL filter function at switch 24), the PIM join signal propagates through the Layer-2 wide-area network to the NNI router 32. In the L3 signaled solution, the network switches are listening to PIM signals being sent between the customer router and the NNI router. The NNI router 32 joins the PIM tree for the requested multicast VLAN carrying the requested data feed by sending a PIM signal to the Exchange NNI router 31, which propagates the signal to the rendezvous point 34. The multicast data feed flows through the exchange network 35 and into the network side NNI router 32 and along the PIM signaled VLAN path through network 1 to the customer router 23, because the switch 24 has opened the port in response to the ACL check in response to the join request. The customer network 21 distributes the multicast data feed to trader stations such as the client device 5 using PIM.

In the L3 signaling example, the actual signaling is a combination of IGMP and PIM. The workstation sends IGMP Join as normal. The customer router translates this into a PIM join. The PIM join propagates through the L2 network, each switch configured with PIM Snooping to passively listen to PIM and open ports for select groups accordingly. The PIM signaling propagates to the NNI router and into the source data provider's PIM network to the Exchange Rendezvous points, which initiates the sending of the feeds it is receiving from the servers down the newly signaled path.

It should be noted that in both types of signaling scenarios the ACL filter function associated with each VLAN effectively separates users into groups authorized to access different data feeds. For example, if a user on the customer B network requested the data feed, but was not authorized, the ACL function of the UNI switch 24 would block access to the particular VLAN data feed. Users authorized to receive a first data feed are grouped to receive that data feed. However, a group of users not authorized to access the first feed, even though authorized to receive a second feed, will be blocked from accessing the VLAN and thus the first data feed.

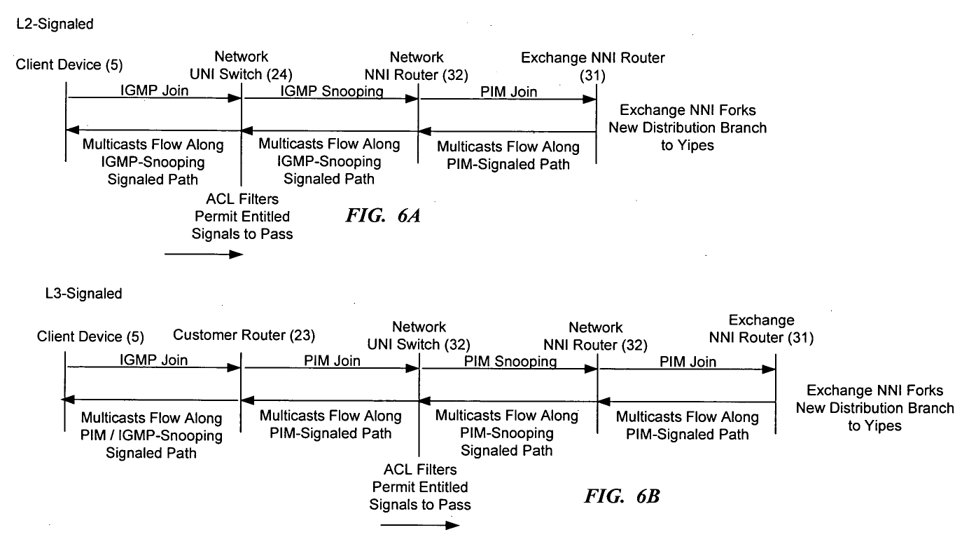

FIGS. 6A and 6B are flow diagrams related to a service scenario, in which an end user requests access to a data feed, at a time when the requested multicast data feed is already flowing on the data provider's network 35, but not through the wide-area network 1. FIG. 6A illustrates an example of this scenario with layer-2 signaling, whereas FIG. 6B illustrates an example of this scenario with layer-3 signaling. In this second scenario, the assumption is that the multicast data feed requested by the user of client device 5 is already propagating through network 35 to other data customers, such as client device 37, via the source or exchange network side NNI router 31.

Up to the Exchange NNI router 31 the scenario of FIG. 6A is identical to the example of FIG. 5A. The client device 5 transmits the IGMP Join type request message identifying the desired feed through the customer network 21 (FIG. 4) to the UNI switch 24 within the wide-area network 1. The switch 24 performs the ACL function, and if the user is authorized, the switch opens the customer port for this data feed and propagates the IGMP Snooping signal through the Layer-2 network 1 to the NNI router 32 co-located at the financial market exchange site. The NNI router 32 propagates a PIM Join signal to the NNI router 31 of the source, the exchange in our example, as in the scenario of FIG. 5A. In this second scenario, however, the exchange NNI router 31 is already feeding the requested data out to a different enterprise. Hence, in the second scenario, the NNI router 31 does not have to send a PIM Join signal since it is already joined to the requested data feed. Instead, it (router 31) adds a branch to the PIM tree and replicates the data to network 1 down this newly created branch, i.e. to allow the data feed to begin flowing through the wide-are network 1.

The network side NNI router 32 forwards the multicast feed, which flows along the IGMP-Snooping signaled path, as a single instance in a provisioned VLAN, as in the example of FIG. 5A. The flow of FIG. 6B is generally similar to that of FIG. 6A, except as in FIG. 5B, the customer router 23 responds to the IGMP Join type request message by sending a corresponding PIM Join signal through the network to the UNI switch 24, which propagates a PIM Snooping signal through the wide-area network 1 to the NNI switch 32.

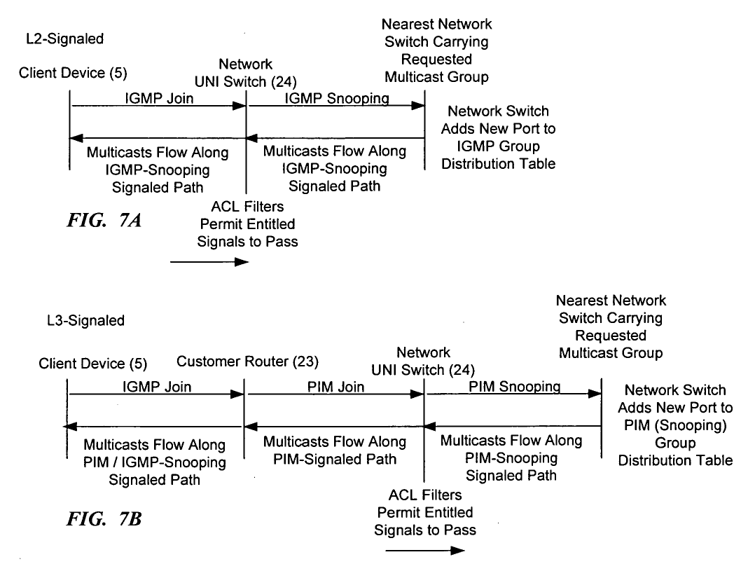

FIGS. 7A and 7B are flow diagrams related to a service scenario, in which the user requested multicast data feed is already flowing through a VLAN in the wide-area network 1. Generally, the Layer-2 and Layer-3 signaling and the ACL processing are similar to those in the earlier examples. However, because the data is already flowing on a VLAN in the wide-area network 1, the signaling only propagates to the nearest switch of the wide area network 1 already registered for the multicast data feed and the associated user group.

Those skilled in the art will recognize that the disclosed network and its operations may be implemented, modified, or applied in a variety of ways within the scope of the exemplary multicast data distribution services.

For an xPLS implementation, the network 1 could use one or more IGMP-Snooping enabled cross-connect switches. The xPLS switches running IGMP will only allow a specific multicast feed to propagate to a region if a client in that region requests the feed. By default the feed is blocked. When the client is done with the feed, they will send an explicit leave, or a timer will automatically disconnect the session and close ports in the path to multicasts (if there are no current subscribers).

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A system for a multicast wide-area data distribution service, comprising:
a layer-two (L2) frame switched wide-area network;
a first switching device on an edge of the wide-area network, for providing a network interface for receiving data from a data source for the multicast wide-area data distribution service, and sending L2 frames containing the received data into the wide-area network, the received data comprising data feeds;
a plurality of second switching devices at various locations on an edge of the wider-area network, for providing instances of a user-network interface for supplying data from the L2 frames to customer premises for delivery to data user client devices; and
L2 virtual local area networks (VLANs) provisioned through the wide-area network to extend from the first switching device to the second switching devices, each VLAN for multicast distribution transport of L2 frames containing one of the data feeds from the first switching device to the second switching devices without replication for individual data user client devices inside the wide-area network;
wherein the user-network interface provided by each second switching device controls the delivery of selected data feeds from the L2 frames of the VLANs responsive to requests for data from the multicast wide-area data distribution service received from one or more respective data user client devices of authorized users.

2. The system of claim 1, wherein the user-network interface configures each of the second switching devices for:
receiving signaling of data requests from one or more of the data user client devices at a respective customer premises, each received request requesting access to one of the data feeds; and
responsive to each received request:
(a) determining whether or not a user associated with a data user client device sending the request is authorized to receive the one data feed from the multicast wide-area data distribution service; and
(b) upon determining that the associated user is authorized to receive the one data feed from the multicast wide-area data distribution service, delivering the one data feed from the L2 frames from a respective one of the VLANs to the one data user client device at the respective customer premises.

3. The system of claim 2, wherein:
the received signaling comprises L2 signaling from the client device at the respective customer premises; and
the delivery comprises delivering the L2 frames containing the one data feed to the client device at the respective customer premises.

4. The system of claim 2, wherein the received signaling comprises layer-three (L3) signaling from the client device at the respective customer premises.

5. The system of claim 4, further comprising:
a router between the first switching device and the data source, for receiving the data from the data source in L3 packets, framing the L3 packets into L2 frames and supplying the resulting L2 frames to the first switching device;
wherein the network interface configures the first switching device for transporting L3 signaling to the data source via the router, in response to signaling from client devices.

6. The system of claim 5, wherein the L3 signaling forms signaling relationships with respect for the data source, through the first and second switching devices.

7. The system of claim 5, wherein the L3 signaling uses Internet Group Multicast Protocol (IGMP) and/or Protocol Independent Multicast (PIM) protocol for supporting management of authorized users of the multicast wide-area data distribution service.

8. The system of claim 2, wherein each of the second switching devices contains an access control list (ACL) with respect to each respective VLAN indicating users authorized to access the data feed contained in the respective VLAN, for use in the determinations of whether or not requesting users are authorized to receive requested data feeds from the multicast wide-area data distribution service.

9. A method for multicast wide-area of data distribution via a layer-two (L2) frame switched wide-area network, the method comprising steps of:
receiving data from a data source for the multicast wide-area data distribution service at a first switching device on an edge of the wide-area network, the received data comprising data feeds;
sending L2 frames containing the data feeds for multicast distribution transport through the wide-area network to a plurality of second switching devices at various locations on an edge of the wider-area network, via respective L2 virtual local area networks (VLANs) provisioned through the wide-area network to extend from the first switching device to the second switching devices, without replication for individual data user client devices inside the wide-area network;
receiving requests for data from the multicast wide-area data distribution service from one or more respective data user client devices, at the second switching devices; and
responsive to received requests for authorized users, supplying selected data feeds from the L2 frames to customer premises for delivery to data user client devices.

10. The method of claim 9, further comprising steps of:
receiving signaling of data requests from one or more of the data user client devices at a respective customer premises, each received request requesting access to one of the data feeds; and
responsive to each received request, determining whether or not a user associated with a data user client device sending the request is authorized to receive the one data feed from the multicast wide-area data distribution service;
wherein the step of supplying comprises, upon determining that the associated user is authorized to receive the one data feed from the multicast wide-area data distribution service, delivering the one data feed from the L2 frames from a respective one of the VLANs to the one data user client device at the respective customer premises.

11. The method of claim 10, wherein:
the received signaling comprises L2 signaling from the client device at the respective customer premises; and
the step of supplying comprises delivering the L2 frames containing the one data feed to the client device at the respective customer premises.

12. The method of claim 10, wherein the received signaling comprises layer-three (L3) signaling from the client device at the respective customer premises.

13. The method of claim 10, wherein the step of determining comprises:
determining whether or not a user associated with the one data user client device is authorized to receive the one data feed from the multicast wide-area data distribution service;
wherein each of the second switching devices contains an access control list (ACL) with respect to each respective VLAN indicating users authorized to access the data feed contained in the respective VLAN, for use in the determinations of whether or not requesting users are authorized to receive requested data feeds from the multicast wide-area data distribution service.

14. The method of claim 10, wherein the data feeds comprise financial market data.
